(19) United States
(12) Patent Application Publication
(10) Pub. No.: US 2013/0056090 A1
(43) Pub. Date: Mar. 7, 2013

(54) FAN ASSEMBLY WITH BACKFLOW PREVENTING STRUCTURE

(71) Applicant: XIAN-XIU TANG, Shenzhen City (CN)

(72) Inventor: XIAN-XIU TANG, Shenzhen City (CN)

(73) Assignees: HON HAI PRECISION INDUSTRY CO., LTD., TU-CHENG (TW); HONG FU JIN PRECISION INDUSTRY (SHENZHEN) CO., LTD., SHENZHEN CITY (CN)

(21) Appl. No.: 13/316,460

(22) Filed: Dec. 10, 2011

(30) Foreign Application Priority Data
Sep. 1, 2011 (CN) 201110256692.2

(51) Int. Cl. F15D 1/00

(52) U.S. Cl. 137/215

(57) ABSTRACT

A fan assembly for a computer system includes a fan and a frame connected to the fan. A number of louvers are rotatably connected to the frame and are capable of rotating between an open position in response to air pressure established by the fan in which air is permitted to flow through the fan, and a closed position under a force of gravity when the fan is inoperable in which the louvers block the air to flow through the fan. Each louver defines at least one groove along a width direction, and each of the at least one groove allows two portions at opposite sides to be broken off from each other.

### BACKGROUND

1. Technical Field

The present disclosure relates to cooling fans, and particularly, to a fan assembly for a computer system with backflow preventing structure.

2. Description of Related Art

One of the most effective techniques of dissipating heat from a component of a computer is to directly apply a relatively high velocity airflow across the surface of the component. Although a fan-based system provides effective component cooling, it has drawbacks. For example, if the fan fails or locks up, there will a failure to cool the component of the computer. One solution in this regard is to incorporate a secondary, redundant fan to protect the component of the computer.

Nonetheless, in those multi-fan arrangements, each fan moves a portion of the air being used for cooling, and the design is usually such that the total cooling capacity of the fans is greater than minimally necessary to cool the computer. Thus if a single fan fails, the airflow created by the remaining functioning fan or fans is intended to be sufficient to cool the system. According to these designs, if one fan fails, the airflow pattern is changed since air will continue to move past the heat generating components near the fans still operating. However, the airflow past the components closest to the failing fan may be considerably reduced, or may even be reversed due to back pressure, thus creating hot spots and interfering with the air flow through the operating fans.

Accordingly, what is needed is a fan-based cooling system in which a single fan failure does not unduly compromise air exchange or directionality of air flow, thereby maintaining effective force-cooling of specified components.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a fan assembly in accordance with an embodiment, showing several louvers in an open position.

FIG. 2 is similar to FIG. 1, but showing the louvers in a closed position.

FIG. 3 is a schematic view of a computer system using a conventional fan.

FIG. 4 is a schematic view of a computer system using the fan assemblies of FIG. 1

FIG. 5 is an isometric view of an assembly of a frame and the louvers of FIG. 1.

FIG. 6 is an isometric, exploded view of the assembly of FIG. 5.

FIG. 7 is planar side view of one louver of FIG. 1.

FIG. 8 is planar bottom view of one louver of FIG. 1.

FIG. 9 is planar front view of the fan assembly of FIG. 1

### DETAILED DESCRIPTION

Embodiments of the present disclosure will now be described in detail with reference to the accompanying drawings.

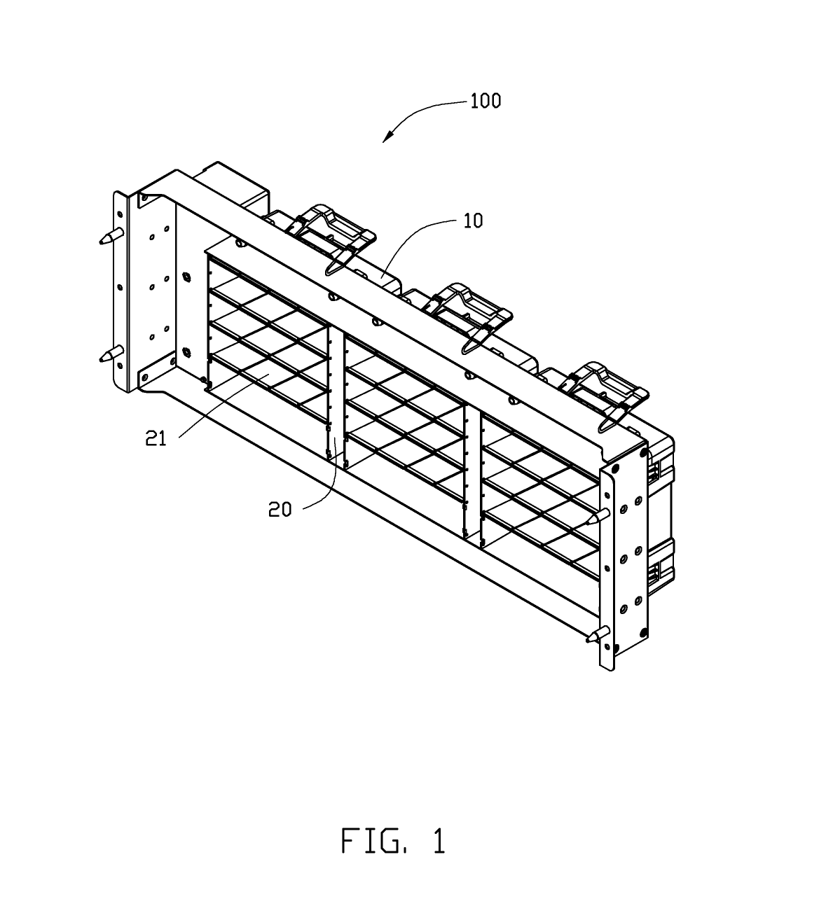

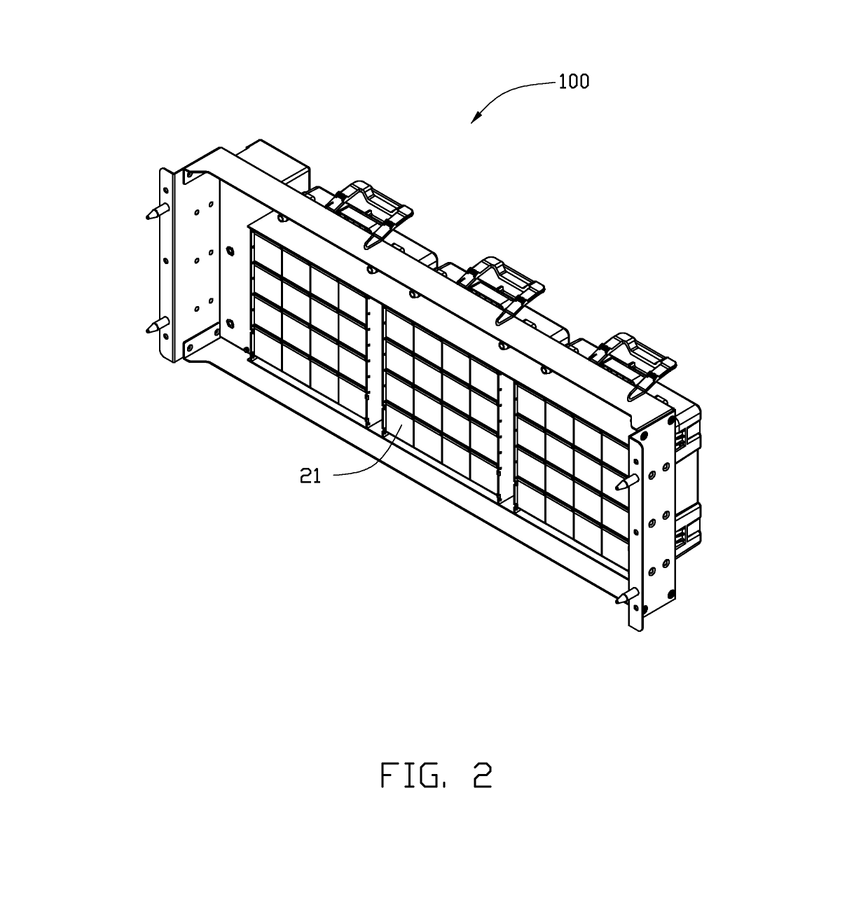

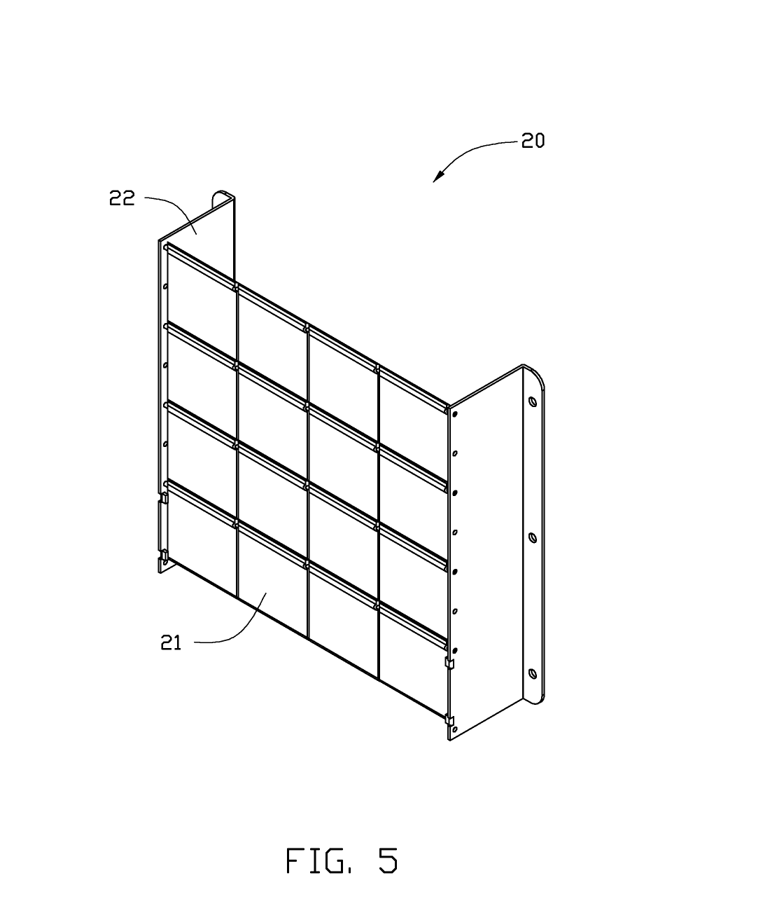

Referring to FIGS. 1 and 2, a fan assembly 100 for use in a computer system includes a fan 10, a frame 22 (FIG. 5) fixed to the fan 10, and a number of louvers 21 rotatably connected to the frame 22. When the fan 10 is in operation, the louvers 21 are driven by the air pressure established by the fan 10 to rotate to an open position (FIG. 1) in which air flow can pass through the fan 10. When the fan 10 is not in operation, the louvers 21 rotate to a closed position (FIG. 2) under the force of their own gravity. The louvers 21 in the closed position substantially form a shield and block airflow to pass through fan 10.

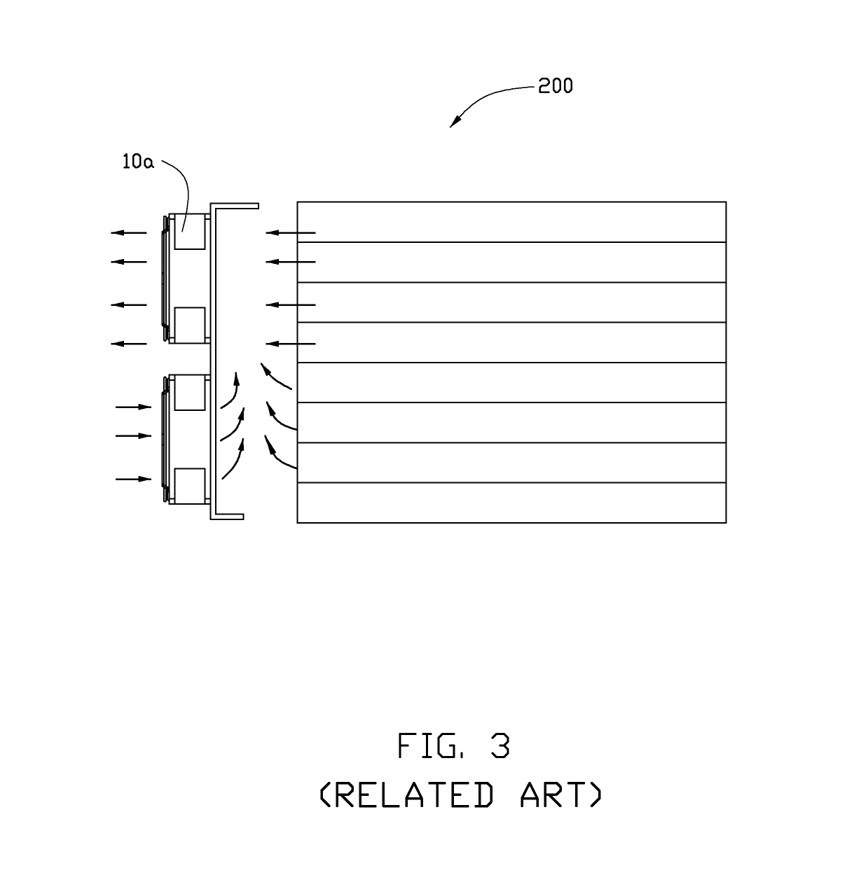

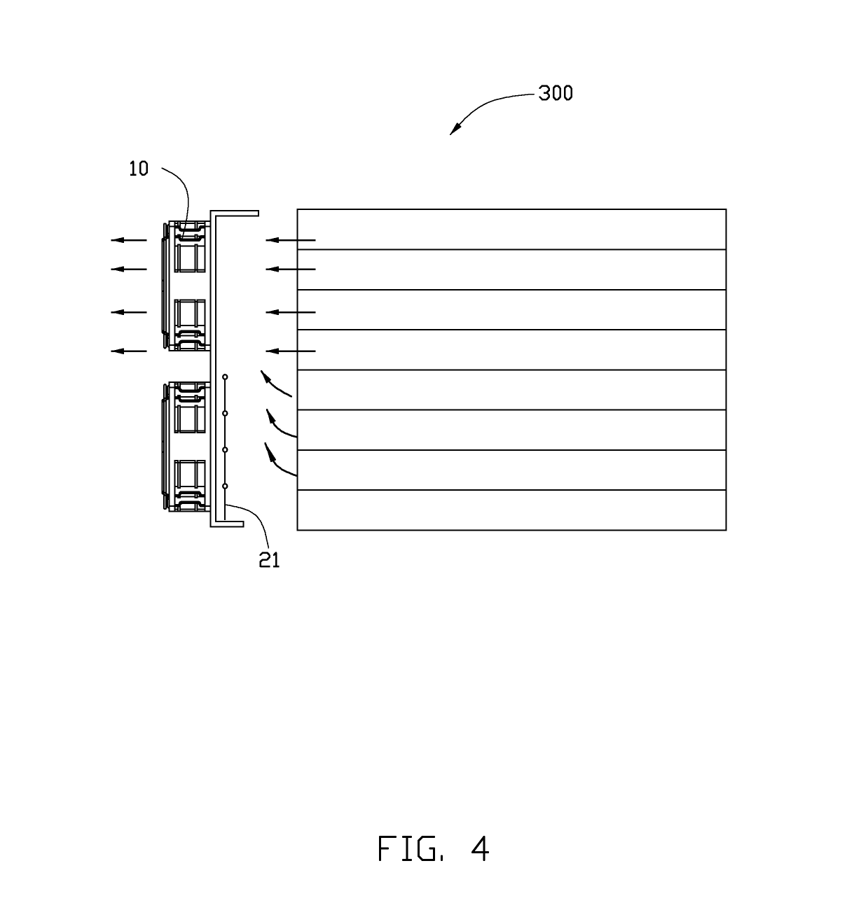

FIG. 3 shows a computer system 200 including two conventional fans 10a. When one fan 10a fails, the air moving out of the computer system 200 via the remaining functioning fan 10a may flow back into the computer system 200 through the failed fan 10a. FIG. 4 shows a computer system 300 utilizing two fan assemblies 100. When one fan 10 fails, the louvers 21 rotate to the closed position and can prevent the air moving out of the computer system 300 via the remaining functioning fan 10 from flowing back into the computer system 300.

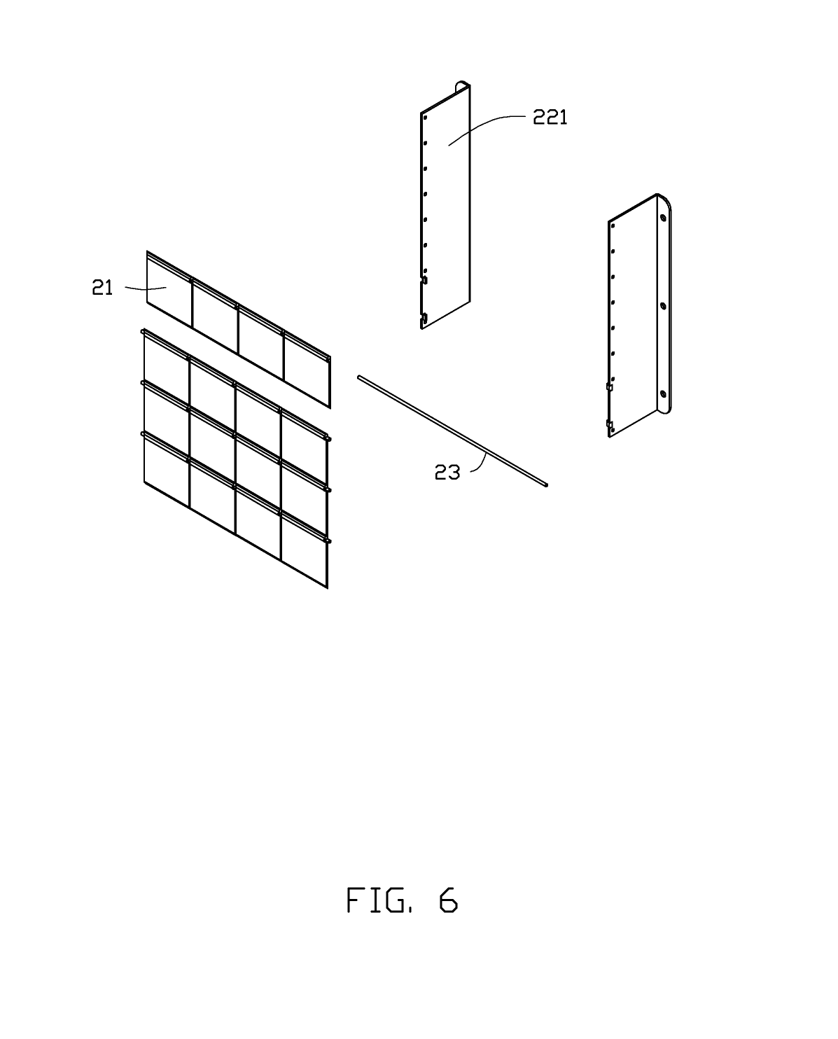

Referring to FIGS. 5 and 6, in the embodiment, the frame 22 includes two support members 221 fixed to the fan 10, and a number of axles 23 each including two ends fixed to the support members 221. Each louver 21 is rotatably connected to one axle 23.

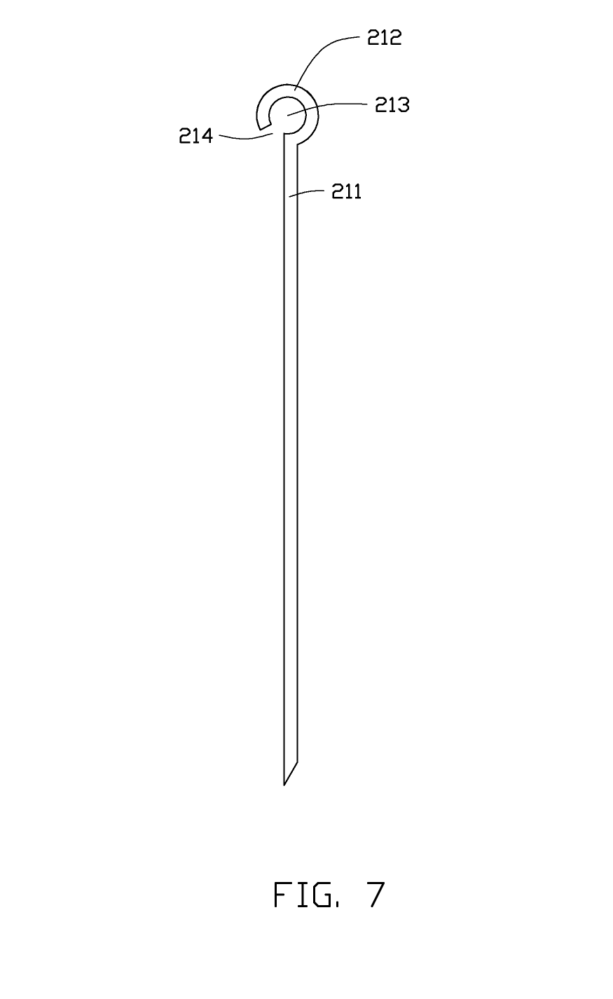

Referring to FIG. 7, in the embodiment, each louver 21 includes a base portion 211 and a connection portion 212 protruding from one end of the base portion 211. The connection portion 212 defines an axle hole 213 extending along its widthwise direction. The axle hole 213 rotatably receives one axle 23, thereby rotatably connecting the louver 21 to the axle 23. In the embodiment, the free end of the connection portion 212 is spaced from the end of the base portion 211, thereby forming a slot 214 extending along the widthwise direction. The slot 214 is sized to allow the axle 23 to pass therethrough, thereby facilitating the manual mounting of the louver 21. The slot 214 can be slightly smaller than the diameter of the axle 23 if the louver 21 is made of elastic material. As such, the slot 214 can be slightly enlarged due to the deformation of the louver 21, enabling the axle 23 to pass through the slot 214. After the louver 21 rebounds, the slot 214 smaller than the axle 23 can prevent the axle 23 from accidentally disengaging from the axle 23.

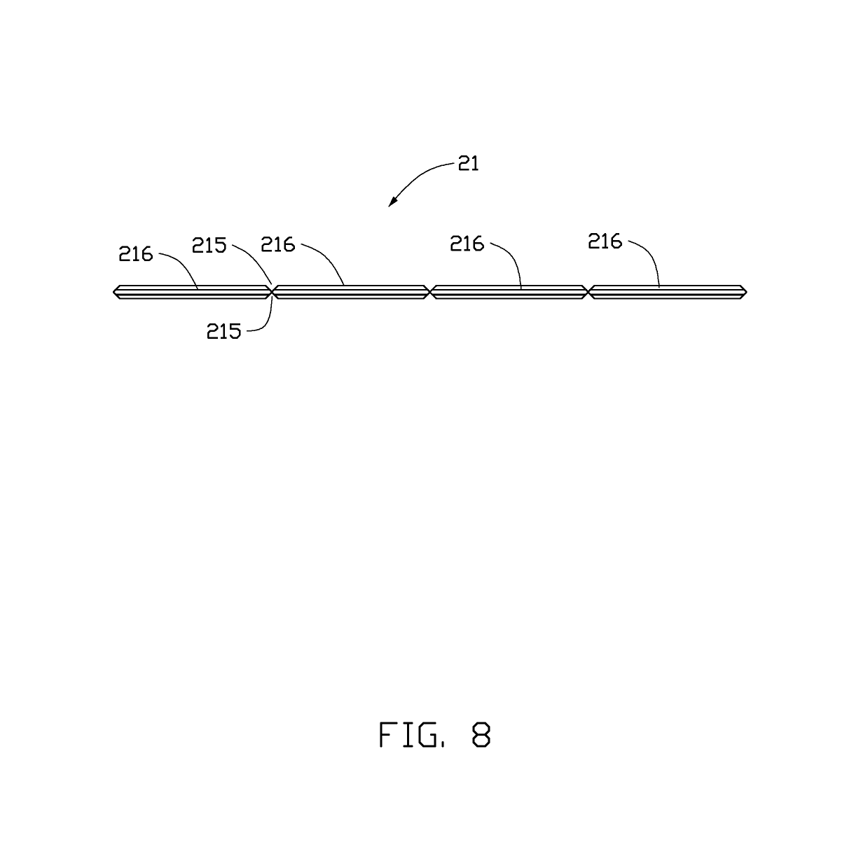

Referring to FIG. 8, each louver 21 defines one or more V-shaped grooves 215. In the embodiment, the grooves 215 are defined at opposite sides of the louver 21. The grooves 215 divide the louver 21 into a number of detachable portions 216. Each two detachable portions 216 at opposite sides of one groove 215 can be broken off from each other. As a result, when needed, one or more detachable portions 216 can be broken off to allow the remaining portion of the louver 21 to adapt a fan of a specific form factor.

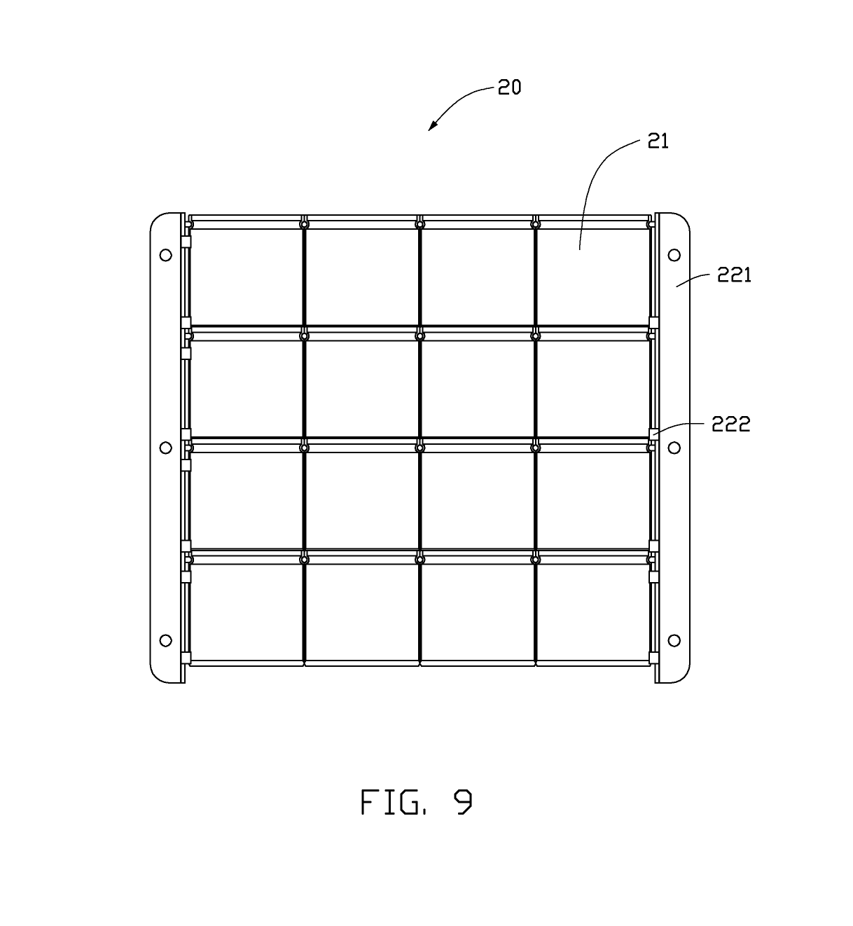

Referring to FIG. 9, each support member 221 includes a number of stop tabs 222 protruding from its longitudinal edge. When the louvers 21 are in the closed position, the stop tabs 222 abut against the louvers 21, thereby preventing an outward rotation of the louvers 21.

While various embodiments have been described and illustrated, the disclosure is not to be construed as being limited thereto. Various modifications can be made to the embodiments by those skilled in the art without departing from the true spirit and scope of the invention as defined by the appended claims.

What is claimed is:

1. A fan assembly for a computer system, comprising:
a fan;
a frame connected to the fan;
a plurality of louvers rotatably connected to the frame, wherein the plurality of louvers are capable of rotating between:
an open position in response to air pressure being established by the fan in which air is permitted to flow through the fan; and
a closed position under a force of gravity when the fan is inoperable in which the plurality of louvers block the air to flow through the fan;
wherein each of the plurality of louvers defines at least one groove along a width direction thereof, and each of the at least one groove allows two portions at opposite sides of the groove to be broken off from each other by bending.

2. The fan assembly according to claim 1, wherein the at least one groove is defined at opposite sides of each of the plurality of louvers.

3. The fan assembly according to claim 1 further comprising a plurality of axles to which the plurality of louvers are rotatable connected.

4. The fan assembly according to claim 3, wherein each of the plurality of louvers comprises a base portion and a connection portion protruding from an end of the base portion, and the connection defines a hole to receive one of the plurality of axles, and comprises a free end spaced from the end of the end of the base portion, which forms a slot that allows the one of the plurality of axles to pass therethrough.

5. The fan assembly according to claim 1, wherein the frame comprises a plurality of tabs to stop rotation of the plurality of louvers.
